(19) United States
(12) Patent Application Publication
(10) Pub. No.: US 2026/0114377 A1
(43) Pub. Date: Apr. 30, 2026

(54) GRASS CLEARING SYSTEM

(71) Applicant: Textron Inc., Providence, RI (US)

(72) Inventor: Stuart Brian Lear Rogers, Ipswich (GB)

(73) Assignee: Textron Inc., Providence, RI (US)

(21) Appl. No.: 18/931,359

(22) Filed: Oct. 30, 2024

(51) Int. Cl. A01D 75/18; A01D 34/00; A01D 34/44; A01D 34/58; A01D 34/66; A01D 34/78

(52) U.S. Cl. CPC A01D 75/187; A01D 34/003; A01D 34/006; A01D 34/44; A01D 34/58; A01D 34/664; A01D 34/78

(57) ABSTRACT

A mower includes a chassis, a tractive element coupled to the chassis, and a mower deck coupled to the chassis. The mower deck includes a housing, a cutting element rotatably coupled to the housing, and an electronic commutation (EC) motor coupled to the housing and the cutting element. The mower also includes a control system configured to operate the mower deck in a cutting mode where, during the cutting mode, the EC motor is controlled to drive the cutting element for cutting grass, and operate the mower deck in a debris clearing mode where, during the debris clearing mode, the EC motor is controlled to drive and then abruptly stop the cutting element to generate a shock through the mower deck for clearing grass accumulation between the housing and the cutting element.

### BACKGROUND

Mowers are used to maintain vegetation (e.g., grass, clover, weeds, etc.) at a desired height. To accomplish this, mowers include at least one cutting unit having a cutting element that is driven by a motor and a driveline that facilitates navigation of the mower throughout an operating area. Mowers typically include operator controls that permit adjustment of a cutting speed of the cutting unit, a cutting height of the cutting unit, and/or a path followed by the mower (e.g., steering). When cutting large areas of vegetation, debris can get caught in the cutting unit. To remove the debris, a user has to stop the mower and manually remove the debris from the cutting element. The user may need to manually remove the debris multiple times to complete a single job adding significant time to complete the job.

### SUMMARY

One embodiment relates to a mower. The mower includes a chassis, a tractive element coupled to the chassis, and a mower deck coupled to the chassis. The mower deck includes a housing, a cutting element rotatably coupled to the housing, and an electronic commutation (EC) motor coupled to the housing and the cutting element. The mower also includes a control system configured to operate the mower deck in a cutting mode where, during the cutting mode, the EC motor is controlled to drive the cutting element for cutting grass, and operate the mower deck in a debris clearing mode where, during the debris clearing mode, the EC motor is controlled to drive and then abruptly stop the cutting element to generate a shock through the mower deck for clearing grass accumulation between the housing and the cutting element.

Another embodiment relates to a mower. The mower includes a chassis, a tractive element coupled to the chassis, and a mower deck coupled to the chassis. The mower deck includes a housing, a cutting element rotatably coupled to the housing, and an electronic commutation (EC) motor coupled to the housing and the cutting element. The mower also includes a control system configured to operate the mower deck in a cutting mode where, during the cutting mode, the EC motor is controlled to drive the cutting element for cutting grass, and operate the mower deck in a debris clearing mode where, during the debris clearing mode, the EC motor is controlled to drive and then abruptly stop the cutting element after each partial rotation intermittently over a period of time or for a number of complete rotations to generate a shock through the mower deck for clearing grass accumulation between the housing and the cutting element, and operate the EC motor to drive the cutting element in a reverse direction following generation of one or more shocks through the mower deck.

Still another embodiment relates to a mower. The mower includes a chassis, a tractive element coupled to the chassis, and a mower deck coupled to the chassis. The mower deck includes a housing, a first cutting element rotatably coupled to the housing, a first electronic commutation (EC) motor coupled to the housing and the first cutting element, a second cutting element rotatably coupled to the housing, and a second EC motor coupled to the housing and the second cutting element. The mower also includes a control system configured to operate the mower deck in a cutting mode where, during the cutting mode, the first and the second EC motor are controlled to drive the first and the second cutting element for cutting grass, and operate the mower deck in a debris clearing mode where, during the debris clearing mode, at least one of (a) the first EC motor and the second EC motor are simultaneously controlled to drive and then abruptly stop the first cutting element and the second cutting element, respectively, to generate a combined shock through the mower deck, or (b) the first EC motor and the second EC motor are separately controlled to drive and then abruptly stop the first cutting element and the second cutting element, respectively, to generate separate shocks at different times through the mower deck.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1A is a perspective view of a vehicle, according to an exemplary embodiment.

FIG. 1B is a perspective view of a vehicle, according to another exemplary embodiment.

FIG. 2 is a schematic block diagram of the vehicle of FIG. 1A, according to an exemplary embodiment.

FIG. 3 is a is schematic block diagram of a site monitoring and control system including a plurality of the vehicles of FIG. 1A, according to an exemplary embodiment.

FIG. 4 is bottom view of a mower deck of a vehicle in a debris clearing mode, according to an exemplary embodiment.

FIG. 5 is perspective view a vehicle in a debris clearing mode, according to an exemplary embodiment.

FIG. 6 is a block diagram of a method for operating a vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

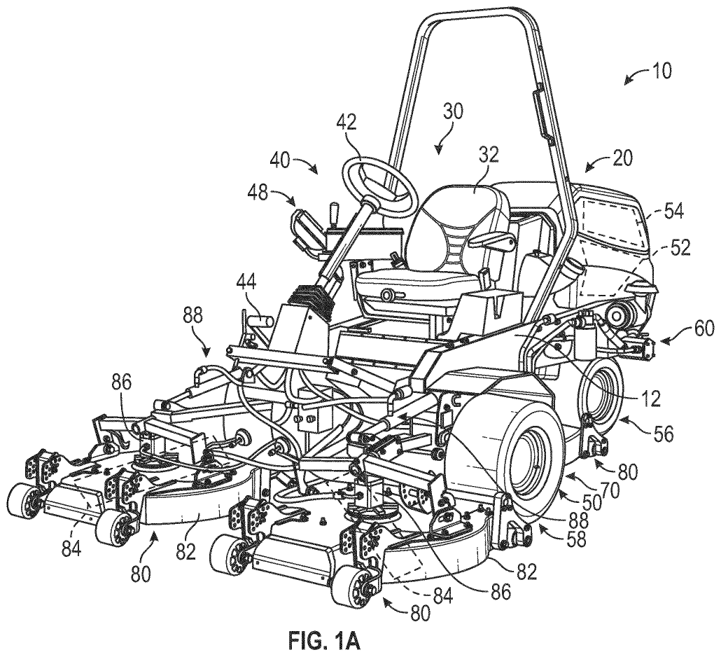

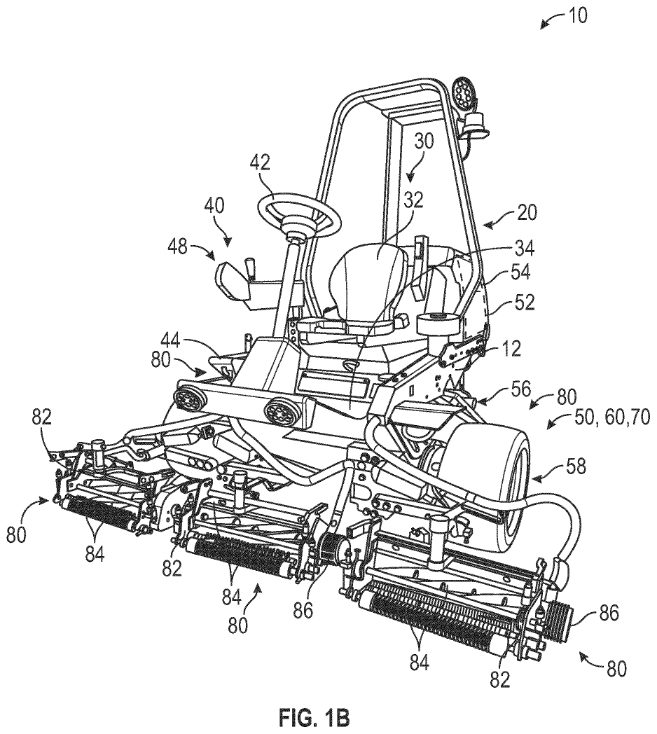

As shown in FIG. 1A-3, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; a series of implements, mower assemblies, or cutting units, shown as mower decks 80; one or more sensors, shown as sensors 90; and a vehicle control system, shown as vehicle controller 100, coupled to the operator controls 40, the driveline 50, the suspension system 60, the braking system 70, the mower decks 80, and the sensors 90. In other embodiments, the vehicle 10 includes more or fewer components.

According to an exemplary embodiment, the vehicle 10 is an off-road machine or vehicle. As shown in FIGS. 1A and 1B, the vehicle 10 is configured as a mower (e.g., a lawnmower, a turf mower, a push mower, a ride-on mower, a stand-on mower, or another type of mower). In other embodiments, the off-road machine or vehicle is a lightweight or recreational machine or vehicle such as a golf cart, golf cars, an all-terrain vehicle (“ATV”), a utility task vehicle (“UTV”), and/or another type of lightweight or recreational machine or vehicle. In some embodiments, the off-road machine or vehicle is a chore product such as aerator, turf sprayer, bunker rake, and/or another type of chore product (e.g., that may be used on a golf course).

According to the exemplary embodiments shown in FIGS. 1A and 1B, the occupant seating area 30 includes a single seat, shown as driver seat 32. In some embodiments, the occupant seating area 30 includes additional seats (e.g., a passenger seat, an additional row of seats, etc.). According to the exemplary embodiments shown in FIGS. 1A and 1B, the driver seat 32 is laterally centered on the body 20 and facing forward. In some embodiments, the driver seat 32 is facing rearward or otherwise positioned. In some embodiments, the occupant seating area 30 is omitted (e.g., the vehicle 10 is configured as a push mower). A portion of the frame 12 defines a platform, deck, or standing area, shown as operator platform 34. The operator platform 34 may extend forward of the driver seat 32 such that the occupant can rest their feet on the operator platform 34 while seated in the driver seat 32. The operator platform 34 may support the occupant as the occupant enters or exits the driver seat 32.

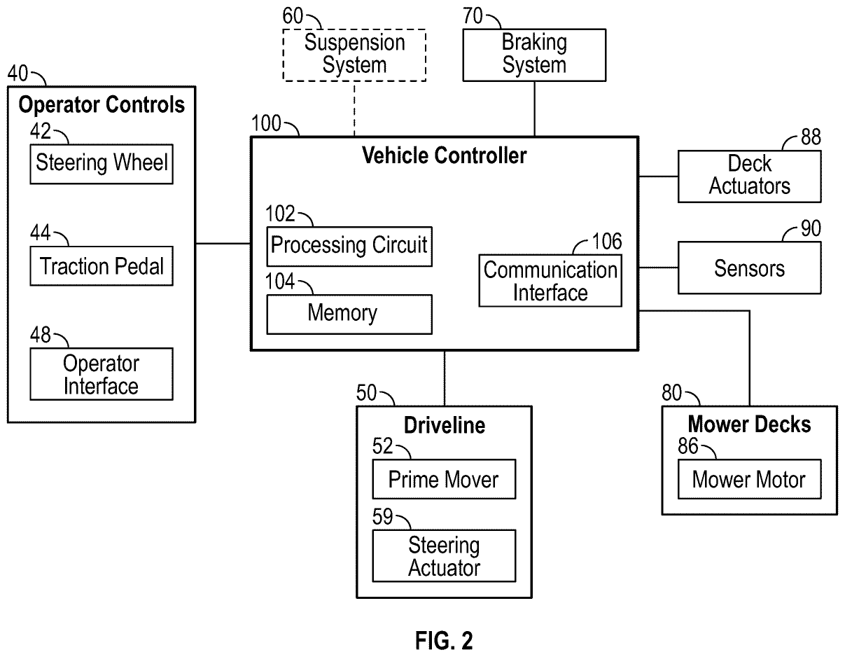

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower a mower deck 80, etc.). As shown in FIGS. 1A, 1B, and 2, the operator controls 40 include a steering interface (e.g., a steering wheel, joystick(s), etc.), shown steering wheel 42, an accelerator interface and/or braking interface (e.g., a pedal, a throttle, etc.), shown as traction pedal 44, and one or more additional interfaces, shown as operator interface 48. The steering wheel 42 may be used by an operator to indicate a desired steering direction of the vehicle 10. The traction pedal 44 may be used to control the speed and direction of travel of the vehicle 10. By way of example, pressing the traction pedal 44 in a first direction may cause the driveline 50 to move the vehicle 10 forward, and pressing the traction pedal 44 in an opposing section direction may cause the driveline 50 to move the vehicle 10 rearward. Returning the traction pedal 44 to a middle or neutral position may cause the braking system 70 and/or the driveline 50 to slow or stop the vehicle 10 or to hold the vehicle 10 in place. Alternatively, the operator interface 48 may include a pair of handles that act as a steering interface and control the driveline 50 in a zero-turn configuration (e.g., a left joystick to control the left side of the driveline 50 and a right joystick to control a right side of the driveline 50). The operator interface 48 may be used to control operation of the mower decks 80 (e.g., changing a cutting speed of a mower deck 80, changing a cutting height of a mower deck 80, etc.). The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1A, 1B, and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is one or more electric motors and the energy storage 54 is a battery system. In some embodiments, the driveline 50 is a fuel cell electric driveline whereby the prime mover 52 is one or more electric motors and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiments shown in FIGS. 1A and 1B, the rear tractive assembly 56 includes rear tractive elements and the front tractive assembly 58 includes front tractive elements that are configured as wheels. In some embodiments, the rear tractive elements and/or the front tractive elements are configured as tracks. In some embodiments, the driveline 50 is omitted, and the vehicle 10 is propelled by an operator (e.g., the vehicle 10 is configured as a push mower).

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., based on an input from the steering wheel 42 and using a steering actuator 59 that controls the orientation of one or more wheels). In some embodiments, both the rear tractive assembly 56 and the front tractive assembly 58 are fixed and not steerable (e.g., employ skid steer operations). By way of example, the driveline 50 may include a hydrostatic transmission that permits independent driving of the left and right sides of the driveline 50.

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the driveline 50 is a hydrostatic transmission that performs braking by using hydraulic motors to oppose movement of the tractive elements.

Referring to FIGS. 1A and 1B, the vehicle 10 includes a series of mower decks 80 (e.g., cutting units). Each mower deck 80 includes a deck, housing, or enclosure, shown as housing 82, and a cutting element 84 (e.g., a blade, a flail, a reel, etc.) movably coupled to the housing 82. Specifically, the vehicle of FIG. 1A illustrates a vehicle 10 in which the mower decks 80 each include a cutting element 84 configured as a blade that rotates about a substantially vertical axis. FIG. 1B illustrates an alternative configuration in which the cutting elements 84 are configured as reels that each rotate about a substantially horizontal axis. Except as otherwise specified, the mower 10 of FIG. 1A may be substantially similar to the mower 10 of FIG. 1B. Accordingly, a description of the mower 10 of FIG. 1A may apply to the mower 10 of FIG. 1B, except as otherwise specified.

Referring to FIGS. 1A and 1B, the housing 82 may open downward to expose the cutting element 84 to vegetation below the housing 82. A motor or actuator (e.g., an electric motor, a hydraulic motor, etc.), shown as mower motor 86, is coupled to the housing 82 and drives movement (e.g., rotation, oscillation, etc.) of the cutting element 84. While driven by the mower motor 86, the cutting element 84 crushes, mulches, removes, or otherwise trims vegetation beneath the housing 82. Alternatively, the cutting element 84 may be driven by the prime mover 52 (e.g., through a power take off). According to an exemplary embodiment, the mower motors 86 are electric commutation (“EC”) motors.

The vehicle 10 includes a series of linear actuators or height adjustment actuators, shown as deck actuators 88, each coupled to the frame 12 and to one or more of the mower decks 80.

The deck actuators 88 permit control over a height of the corresponding mower deck 80 relative to the frame 12. The deck actuators 88 may set a cutting height of the mower deck 80. The cutting height represents a final height of vegetation that is trimmed by the mower deck 80. The deck actuators 88 may move the mower deck 80 to a travel position above the cutting height, in which the mower deck 80 is moved out of engagement with the vegetation and the ground surface. The travel position may be used when the vehicle 10 is traveling between job sites and/or the user does not wish to be trimming vegetation.

The sensors 90 may include various sensors positioned about the vehicle 10 to acquire vehicle information or vehicle data regarding operation of the vehicle 10, or the location thereof. The sensors 90 may include various sensors positioned about the vehicle 10 to acquire environment data regarding the environment surrounding the vehicle 10. By way of example, the sensors 90 may include an accelerometer, a gyroscope, a compass, a position sensor (e.g., a GPS sensor, an RTK sensor, etc.), an inertial measurement unit (“IMU”), suspension sensor(s), wheel sensors, an audio sensor or microphone, a camera, an optical sensor, a proximity detection sensor, linear potentiometers, and/or other sensors to facilitate acquiring vehicle information, vehicle data, or environment data regarding operation of the vehicle 10, the location thereof, and/or the surrounding environment. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

As shown in FIG. 2, the vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communication interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communication interface 106, a controller area network (“CAN”) bus, etc.). According to an exemplary embodiment, the vehicle controller 100 is coupled to (e.g., communicably coupled to) components of the operator controls 40 (e.g., the steering wheel 42, the traction pedal 44, the brake 46, the operator interface 48, etc.), components of the driveline 50 (e.g., the prime mover 52), components of the braking system 70, the mower decks 80, the deck actuators 88, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communication interface 106 as described in greater detail herein).

The communication interface 106 facilitate communications (e.g., wired or wireless communications) between the vehicle 10 and other devices (e.g., other vehicles 10, the user sensors 220, the user portal 230, the remote systems 240, etc.). By way of example, the communications interface 130 may be configured to employ one or more types of wireless communications protocols including Bluetooth, Wi-Fi, radio, cellular, and/or other suitable wireless communications protocols.

### Site Monitoring and Control System

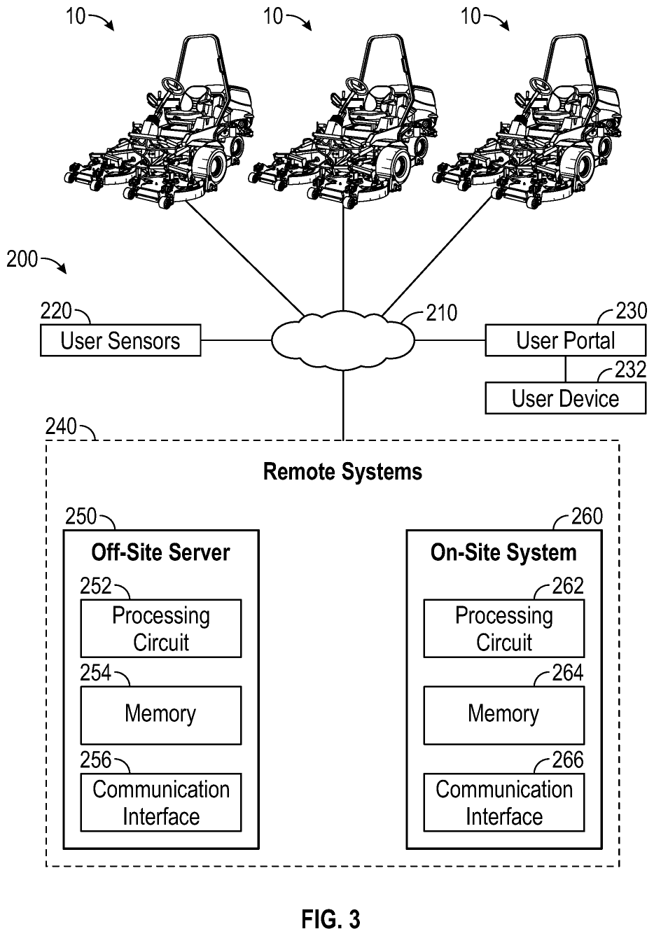

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210 (e.g., using the communication interface 106).

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc. ; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may be or may be accessed via a computer, laptop, smartphone, tablet, or the like.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Grass Clearing System

According to an exemplary embodiment, the site monitoring and control system 200, including the vehicle controller 100, the mower decks 80, the user sensors 220, the user portal 230, the user device 232, and the remote systems 240 (which may be referred to herein as a “remote access system” or a “display emulator system”), is configured to facilitate removal of grass and/or debris from the mower decks 80 during operation of the vehicle 10 such that the user does not have to manually remove the grass and/or debris from the mower deck 80 providing a more efficient mow of vegetation.

According to an exemplary embodiment, the vehicle 10 is operable in various modes (e.g., a cutting mode, a debris clearing mode, etc.) as commanded by the user (e.g., the operator of the vehicle 10, etc.), sensed data from the sensors 90 indicating ground operating conditions of the vehicle 10 and/or ground conditions, or as commanded from a remote device of the remote system 240.

### Cutting Mode

According to an exemplary embodiment, the vehicle 10 is operable in a mowing mode or a cutting mode. When the vehicle 10 is operated in the cutting mode, the vehicle controller 100 is configured to control the mower motor 86 to rotate or drive the cutting element 84 for cutting vegetation, such as grass. As shown in FIGS. 1A and 1B, when in the cutting mode, the mower deck 80 is positioned in a lower or a down position such that the cutting elements 84 can engage with the grass. For example, the height of the mower deck 80 is adjustable by the deck actuators 88 and controlled, by the vehicle controller 100, to lower the mower deck 80 when the vehicle 10 is in the cutting mode. The mower motor 86 is then controlled by the vehicle controller 100 to drive (e.g., provide torque to, etc.) the cutting elements 84, causing the cutting elements 84 to rotate in a first direction and at a first or cutting speed. In some embodiments, the first direction is a clockwise direction. In some embodiments, the vehicle controller 100 is configured to control each of the deck actuators 88 and the mower motors 86 via command signals to operate the cutting elements 84 in the same direction, at substantially the same speed, and at substantially the same height. In other embodiments, the vehicle controller 100 is configured to provide a plurality of different command signals to the mower motors 86 and/or the deck actuators 88 to operate one or more of the cutting elements 84 in different directions, at different speeds, and/or at different heights. For example, the vehicle controller 100 may send a command, such as different commands, to each mower motor 86 to drive the respective cutting element 84 in a manner that is different from the other cutting elements 84. For example, the vehicle controller 100 can control each of the mower motors 86 to drive the cutting elements 84 in different directions or at different speeds.

In some embodiments, the vehicle controller 100 is configured to control the mower motors 86 to drive each of the cutting elements 84 at a desired speed (e.g., faster, slower, etc.) based on at least one of the position of the traction pedal 44 (e.g., how far the user presses down on the traction pedal, etc.), sensor data from the sensors 90, ground conditions determined by the sensors 90 and/or a camera, or an input from a remote operator and/or from the remote systems 240. For example, the vehicle controller 100 may command the mower motors 86 to speed up when the grass is exceptionally thick.

In some embodiments, the vehicle controller 100 is configured to operate the vehicle 10 in the cutting mode based on an input received from the operator of the vehicle 10. By way of example, the operator may provide a command to the operator interface 48 to engage the cutting mode. By way of another example, the operator may provide a command to the user device 232 to initiate operation of the vehicle 10 in the cutting mode. In some embodiments, the vehicle controller 100 is configured to operate the vehicle 10 in the cutting mode in response to the operator additionally engaging the traction pedal 44. In some embodiments, the vehicle controller 100 is configured to operate the vehicle 10 in the cutting mode in response to a command signal from the remote systems 240. By way of example, the remote systems 240 may remotely control operation of the vehicle 10 during an autonomous or assisted mowing operation and control the modes of operation of the vehicle 10. By way of another example, the remote systems 240 may remotely control operation of the vehicle 10 during a remote operator mowing operation based on commands received via the user device 232 by a remote operator.

### Debris Clearing Mode

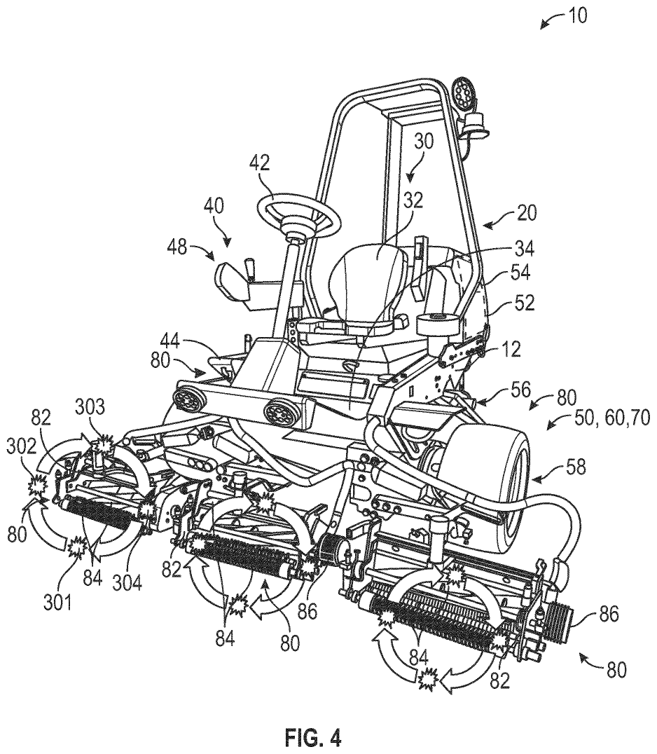

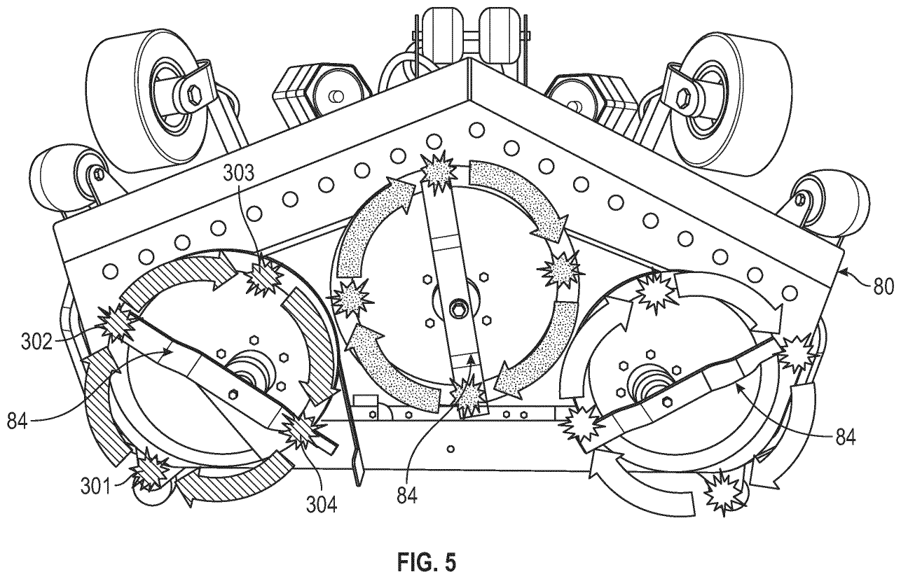

According to an exemplary embodiment, the vehicle 10 is operable in a debris removal or debris clearing mode. As shown in FIGS. 4 and 5, the vehicle 10 is selectively operated in a debris clearing mode. When the vehicle 10 is in the debris clearing mode, the vehicle controller 100 is configured to control the mower motors 86 to drive and then suddenly, or abruptly, stop the cutting elements 84. As such, the vehicle controller 100 is configured to generate one or more shocks, shows as shocks 301-304, through the mower deck 80 by abruptly stopping the cutting elements 84 to clear or dislodge grass and/or debris from the cutting elements 84 and from between the housing 82 and edges of the cutting elements 84. According to an exemplary embodiment, the cutting elements 84 are steel blades or reels that when rotated, have substantial momentum, thus abruptly stopping the blades of the cutting element 84 generate a substantial shock that causes the mower deck 80 to jolt or shake. In some embodiments, the vehicle controller 100 is configured to control the cutting elements 84 to generate the shocks 301-304 in a sequence or pattern such that grass is intermittently cleared from the cutting elements 84. For example, the vehicle controller 100 operates the vehicle 10 in the cutting mode, intermittently operates the vehicle 10 in the debris clearing mode, and then returns to operating the vehicle 10 in the cutting mode. By controlling the vehicle 10 to intermittently operate in the debris clearing mode, debris build-up on the cutting elements 84 and between the cutting elements 84 and the housing 82 is minimized such that impediment of the rotation of the cutting elements 84 (e.g., jamming of the cutting elements 84, etc.) is also minimized. For example, the vehicle controller 100 controls the mower motors 86 to drive, or provide torque, to the cutting elements 84 causing, for example the blades, of the cutting elements 84 to rotate cutting the grass. The vehicle controller 100 then controls the mower motors 86 to drive the cutting elements 84 similar to the cutting mode, or at a faster speed, and then suddenly stops the cutting elements 84 from rotating causing the grass and/or debris to fall off of the blades of the cutting element 84 and from between the cutting element 84 and the housing 82.

As shown in FIGS. 4 and 5, when operating the vehicle 10 in the cutting mode, the mower motors 86, which according to this exemplary embodiment are EC motors, receive current in a first direction (e.g., a forward direction, etc.) causing the cutting elements 84 to rotate in the first direction or, for example, a clockwise direction. To abruptly stop the cutting elements 84, the vehicle controller 100 is configured to reverse the current to an opposing second direction for a period of time (e.g., a fraction of a second, less than one second, etc.) causing the cutting elements 84 to abruptly stop. In some embodiments, the vehicle controller 100 can reverse the current provided to the mower motors 86 for a longer period of time (e.g., a few seconds, etc.) causing the cutting element 84 to stop and then rotate in a reverse direction (e.g., a direct opposite the first direction, counterclockwise, etc.). By rotating the cutting element 84 in the reverse direction, grass may be further cleared from the cutting element 84 and from in between the cutting element 84 and the housing 82.

According to an exemplary embodiment, when operating the vehicle 10 in the cutting mode, the vehicle controller 100 is configured to control the mower motors 86 to drive the cutting elements 84 at a first speed that is a cutting speed. In some embodiments, the cutting speed is determined by the user (e.g., via an input to the communication interface 106, from a remote user, etc.). In other embodiments, the cutting mode is selected, for example by the user, and the vehicle controller 100 determines, based on data (e.g., ground saturation, ground conditions, terrain, etc.) received from the sensors 90, the cutting speed. For example, the cutting speed can be tailored, or adjusted, based on the ground conditions on a given day determined by the sensors 90. Once an input or command is received, either by the user or determined by the sensors 90, to operate the vehicle 10 in the debris clearing mode, the vehicle controller 100 controls the mower motors 86 to abruptly stop or slow down the cutting element 84 to near a stop causing the grass to be dislodged from the cutting element 84 and/or between the cutting element 84 and the housing 82. In some embodiments, the cutting elements 84 are completely stopped prior to engaging the debris clearing mode.

As shown in FIGS. 4 and 5, when operating the vehicle 10 in the debris clearing mode, the vehicle controller 100 is configured to control the mower motor 86 to drive, or power, the cutting elements 84 to rotate at a desired or predetermined rate or speed. In some embodiments, the vehicle controller 100 controls the mower motors 86 to drive the cutting elements 84 in the debris clearing mode at the same speed (e.g., a first speed, the cutting speed, etc.) as the mower motors 86 drive the cutting elements 84 in the cutting mode. However, in the cutting mode, the cutting elements 84 are driven continuously at, or about, the same speed. Instead, in the debris clearing mode, the mower motors 86 are configured to intermittently and abruptly stop the cutting elements 84 causing the shocks 301-304 and/or pulse to flow through the mower deck 80 (e.g., shaking or jolting the mower deck 80, etc.) causing built-up grass and/or debris to be cleared from the cutting elements 84 and from within the housing 82. In other embodiments, the vehicle controller 100 is configured to control the mower motors 86 to drive the cutting elements 84 at a speed (e.g., a second speed, etc.) that is faster than the cutting speed (e.g., the first speed, etc.) that the mower motors 86 drive the cutting elements in the cutting mode. By driving the cutting elements 84 in the debris clearing mode at the second speed that is greater than the first speed of the cutting mode, and then abruptly stopping the cutting elements 84, a larger shock or pulse (e.g., a shock of greater force, etc.) is generated and through the mower deck 80. The shock (e.g., force, etc.) that flows through the mower deck 80 caused by abruptly stopping the rotation of the cutting elements 84 causes the mower deck 80 to jolt or shake loosening the grass stuck to the blades of the cutting elements 84 and stuck between the edges of the blades and the housing 82.

According to an exemplary embodiment, during the debris clearing mode, the vehicle controller 100 is configured to control the mower motors 86 to stop the cutting elements 84 after the cutting elements 84 complete less than one full rotation of the cutting element 84. Such process may be repeated multiple times in succession. As shown in FIGS. 4 and 5, the vehicle controller 100 is configured to control the mower motors 86 to stop the cutting elements 84 after every about 90 degrees of rotation (e.g., a quarter of a rotation, a first debris clearing mode, etc.) such that each of the shocks 301-304 are generated during one complete rotation. In other embodiments, the vehicle controller 100 controls the mower motors 86 to stop the cutting elements 84 after each time the cutting elements 84 complete about 180 degrees of rotation (e.g., a half of a rotation, a second debris clearing mode, etc.). In yet another embodiments, the vehicle controller 100 controls the mower motors 86 to stop the cutting elements 84 after each time the cutting elements 84 complete about 360 degrees of rotation (e.g., a complete rotation, etc.)(e.g., a third debris clearing mode, etc.). In another embodiment, the vehicle controller 100 controls the mower motors 86 to stop the cutting elements 84 after each time the cutting elements 84 completes a specified number of rotations (e.g., a fourth debris clearing mode, etc.). For example, the vehicle controller 100 controls the mower motors 86 to drive the cutting elements to complete a number of full rotations (e.g., two rotations, three rotations, etc.) and then abruptly stop the cutting elements 84. The vehicle controller 100 can control the mower motors 86 to repeatedly drive the cutting elements 84 to complete two or three rotations and then abruptly stop the cutting elements 84. In yet another embodiment, the vehicle controller 100 controls the mower motors 86 to drive the cutting elements 84 at the cutting speed for an amount of time (e.g., three minutes, five minutes, eight minutes, etc.) and then abruptly stop the cutting elements 84 (e.g., a fifth debris clearing mode, etc.). In still another embodiment, the vehicle controller 100 controls the mower motors 86 to abruptly stop the cutting elements 84 based on an operating condition or a state of the vehicle 10 (e.g., a sixth debris clearing mode, etc.). For example, the vehicle controller 100 may control the mower motors 86 to abruptly stop the cutting elements 84 when the vehicle 10 is turning or when the mower deck 80 is raised. In another embodiment, the vehicle controller 100 controls the mower motors 86 to drive the cutting elements at either the cutting speed or the debris clearing speed, abruptly stop the cutting elements 84 (e.g., after an amount of time or a number of rotation, etc.), and then drive the cutting elements 84 in a reverse direction (e.g., by reversing the voltage through the EC motors, etc.) (e.g., a seventh debris clearing mode, etc.). Generating a shock or pulse through the mower deck 80 and then reversing the direction of rotation of the cutting elements 84 may further loosen grass and/or debris that is stuck to or around the cutting element 84 and then causes the grass and/or debris to fall off of the cutting element 84 (e.g., by rotating the opposite direction of the cutting mode causing debris to be pulled off by friction with the ground and/or fall off, etc.).

In some embodiments, the vehicle controller 100 receives an input from the user device 232 or the remote systems 240 indicating to the vehicle controller 100 to operate the vehicle 10 in the cutting mode or the debris clearing mode. The embodiments described above (e.g., the first-seventh debris clearing modes, etc.) are stored in at least one of the memory 104, the memory 254, or the memory 264, such that user/operator of the vehicle 10 or a remote operator can control and/or switch between various debris clearing codes. It is advantageous to determine and/or switch the debris clearing mode based on current ground conditions and/or the terrain being mowed.

According to some embodiments, the user/operator of the vehicle 10 provides an input to the operator interface 48, such as a push of a button or a switch, that initiates operating the vehicle in the debris clearing mode. For example, the user pushes a button causing the vehicle controller 100 to control the mower motor 86 to operate in the debris clearing mode (e.g., one of the first though seventh clearing modes as described above, etc.) until a second input, such as a release of the button or switch and selection of the cutting mode, is provided or received.

In some embodiments, the vehicle controller 100 is configured to operate the vehicle 10 in the debris clearing mode based on an input received from the operator of the vehicle 10. By way of example, the operator may provide a command to the operator interface 48 to engage the debris clearing mode. By way of another example, the operator may provide a command to the user device 232 to initiate operation of the vehicle 10 in the debris clearing mode. In some embodiments, the vehicle controller 100 is configured to operate the vehicle 10 in the debris clearing mode in response to the operator additionally raising the mower deck 80. In some embodiments, the vehicle controller 100 is configured to operate or suggest to the operator to operate the vehicle 10 in the debris clearing mode based on data acquired via the sensors 90 (e.g., indicating resistance to the cutting elements 84). In some embodiments, the vehicle controller 100 is configured to operate the vehicle 10 in the debris clearing mode in response to a command signal from the remote systems 240. By way of example, the remote systems 240 may remotely control operation of the vehicle 10 during an autonomous or assisted mowing operation and control the modes of operation of the vehicle 10. By way of another example, the remote systems 240 may remotely control operation of the vehicle 10 during a remote operator mowing operation based on commands received via the user device 232 by a remote operator.

In some embodiments, the vehicle controller 100 is configured to control the mower motors 86 to intermittently, or at predetermined intervals (e.g., every five minutes, every ten minutes, after each cutting pass, when turning around to make a subsequent pass, etc.), engage the debris clearing mode. For example, when operating the vehicle 10, the vehicle controller 100 controls the mower motors 86 to drive the cutting elements 84 in the cutting mode at the cutting speed (e.g., the first speed, etc.) and then, after a present about of time elapsing or the cutting element completing a specified number of rotations, engage the debris clearing mode.

As shown in FIGS. 1, 4, and 5, the vehicle 10 includes a plurality of mower decks 80 (e.g., three mower decks, two mower decks, four mower decks, etc.) or the mower deck 80 includes a plurality of mower mowers 86 and a plurality of cutting elements 84. The vehicle controller 100 is configured to control each of the mower motors 86 with a single command, or control each of the mower motors 86 with separate commands (e.g., individually, etc.) such that each mower motor 86 is operated differently or at different timing. For example, the vehicle controller 100 can control each mower motor 86 to drive each respective cutting element 84 in either the cutting mode or the debris clearing mode. In another embodiment, the vehicle controller 100 operates one of the mower motors 86 (e.g., a first mower motor 86( in the cutting mode, and simultaneously, or at about the same time, control another one of the mower motors 86 (e.g., a second mower motor 86) to operate in the debris clearing mode (e.g., one of the first through seventh debris clearing modes as described above, etc.).

In some embodiments were the vehicle 10 includes a mower deck 80 including a plurality of mower motors 86 and a plurality of cutting elements 84, as shown in FIG. 5, the vehicle controller 100 is configured operate the mower deck 80, during the debris clearing mode, such that each of the mower motors 86 (e.g., a first mower motor, a second mower motor, etc.) are simultaneously controlled to drive and then abruptly stop the cutting elements 84 simultaneously to generate a combined shock through the mower deck 80.

In some embodiments were the vehicle 10 includes a mower deck 80 including a plurality of mower motors 86 and a plurality of cutting elements 84, as shown in FIG. 5, the vehicle controller 100 is configured operate the mower deck 80, during the debris clearing mode, such that each of the plurality of mower motors 86 (e.g., a first mower motor, a second mower motor, a third mower motor, etc.) are separately controlled to drive and then abruptly stop the their respective cutting elements 84 to generate separate shocks at different times through the mower deck 80. In some embodiment, the vehicle controller 100 is configured to repeat the sequence one or more additional times to regenerate the separate shocks.

In some embodiments were the vehicle 10 includes a plurality of mower decks 80, as shown in FIGS. 1A, 1B, and 4, each of the plurality of mower decks 80 may be independently operable in the cutting mode and the debris clearing mode. For example, the vehicle controller 100 can generate a first shock through a first mower deck 80 at a first point in time clearing the grass and/or debris from the first mower deck 80 and generate a second shock through a second mower deck 80 at a second point in time clearing the grass and/or debris from the second mower deck 80. As such, the vehicle controller 100 can control each of the mower decks 80 independent of the other mower decks 80. In some embodiments, the vehicle controller 100 is configured to receive data (e.g., a cutting element speed change, etc.), such as one of the cutting elements 84 bogging down from debris build-up, from one of the sensor 90, and the vehicle controller 100 operates one of the mower decks 80 in the debris clearing mode while continuing to operate the other mower decks 80 in the cutting mode.

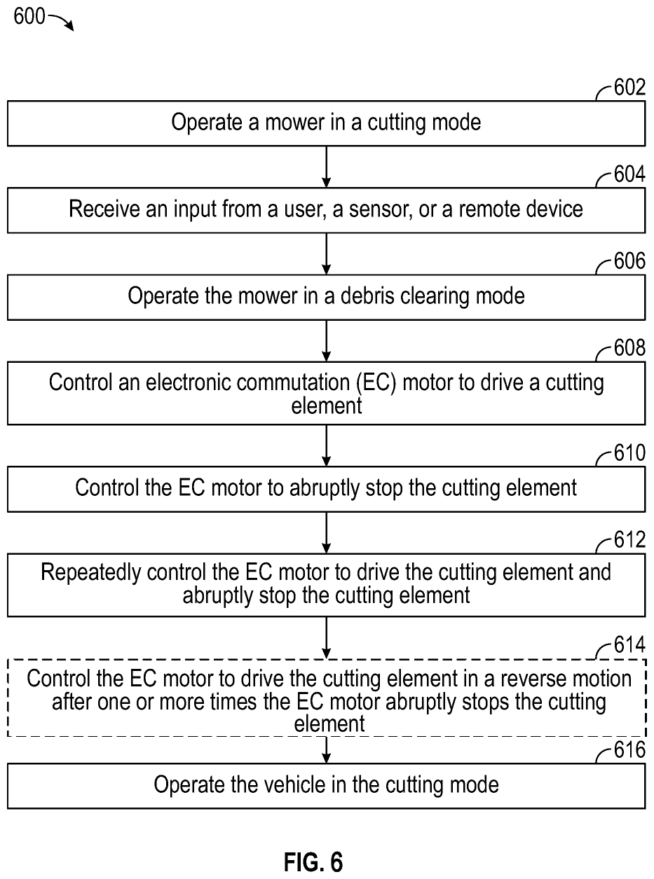

Now referring to FIG. 6, a method 600 for operating a vehicle, such as the vehicle 10 is shown, according to an exemplary embodiment. As shown in FIG. 6, the method 600 begins with operating (e.g., by a local user/operator, remotely, autonomously, etc.) the vehicle 10 in a cutting mode at step 602. According to this embodiment, the vehicle is a mower operated to cut grass.

During operation of the vehicle, vehicle signals or inputs, such as CAN signals or sensor signals, are acquired from the on-board user, a remote user/device, and/or an onboard sensor (e.g., sensor 90, etc.) regarding operation of the vehicle at step 604. For example, a communication interface (e.g., the communication interface 106, etc.) of the vehicle may acquire the inputs from the on-board user or from a remote user of the remote system 240. In some embodiments, at step 604, the on-board user may provide an input, such as selecting a button on the operator interface 48, to initiate operating the vehicle 10 in the debris clearing mode. In other embodiments, the input is received by the remote system 240 and the remote system 240 transmits the signal to the vehicle controller 100. In other embodiments, at step 404, the vehicle controller 100 receives a signal from the sensors 90 as the input.

At step 606, the vehicle 10 is operated in a debris clearing mode. For example, the vehicle controller 100 switches operation of the vehicle 10 from the cutting mode to the debris clearing mode in response to the input.

At step 608, an EC motor or motors (e.g., the mower motors 86, etc.) are controlled to drive a cutting element or a plurality of cutting elements (e.g., the cutting elements 84, etc.). For example, the vehicle controller 100 controls the EC motor or motors (e.g., the mower motors 86, etc.) to drive the cutting element or the plurality of cutting elements (e.g., cutting elements 84, etc.).

At step 610, the EC motor or motors (e.g., the mower motors 86, etc.) are controlled to abruptly or suddenly stop the cutting element or the plurality of cutting elements. For example, the vehicle controller 100 controls the EC motor or motors to stop the cutting element or the plurality of cutting elements to generate one or more shocks (e.g., the shocks 301-304)through one or more mower decks (e.g., the mower decks 80), causing grass and/or debris to be removed or dislodged from and around the cutting elements.

At step 612, the EC motor or motors are repeatedly controlled to drive the cutting element(s) and abruptly stop the cutting element(s). For example, the EC motors can be controlled to operate in any one of the first through seventh debris clearing modes as described above for a period of time or until a second input is received to return operation to the cutting mode. In some embodiments, the vehicle controller 100 implements repeated control of the EC motors, and in other embodiments, the user may provide a plurality of inputs to repeatedly control the EC motors.

At step 614, the EC motor is controlled to drive the cutting element in a reverse motion after one or more times that the EC motors abruptly stop the cutting elements. For example, the vehicle controller 100 controls the mower motor 86 to drive the cutting element 84, abruptly stop the cutting element 84, and then drive the cutting element in the reverse direction before resuming driving the cutting element 84 in a forward direction (e.g., similar to a cutting mode direction, etc.). Such reverse motion may occur after each shock or at the end of the debris clearing mode before transitioning back to the cutting mode.

At step 616, the vehicle is operated in the cutting mode. For example, the vehicle controller 100 receives a second input or command from the on-board user or the remote systems indicating to resume operation of the vehicle 10 in the cutting mode to cut the grass.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the vehicle controller 100, etc.) as shown in the various exemplary embodiments is illustrative only. Additionally, any element disclosed in one embodiment may be incorporated or utilized with any other embodiment disclosed herein. By way of example, a vehicle controller 100 may utilize both precision mowing and adaptive mowing.

1. A mower comprising:
a chassis;
a tractive element coupled to the chassis;
a mower deck coupled to the chassis, the mower deck including:
a housing;
a cutting element rotatably coupled to the housing; and
an electronic commutation (EC) motor coupled to the housing and the cutting element; and
a control system configured to:
operate the mower deck in a cutting mode where, during the cutting mode, the EC motor is controlled to drive the cutting element for cutting grass; and
operate the mower deck in a debris clearing mode where, during the debris clearing mode, the EC motor is controlled to drive and then abruptly stop the cutting element to generate a shock through the mower deck for clearing grass accumulation between the housing and the cutting element.

2. The mower of claim 1, wherein the EC motor drives the cutting element at a cutting speed during the cutting mode and a debris clearing speed during the debris clearing mode.

3. The mower of claim 2, wherein the debris clearing speed is different than the cutting speed.

4. The mower of claim 3, wherein the debris clearing speed is faster than the cutting speed.

5. The mower of claim 1, wherein, when operating the mower deck in the debris clearing mode, the control system is configured to control the EC motor to abruptly stop the cutting element after less than one full rotation of the cutting element.

6. The mower of claim 5, wherein, when operating the mower deck in the debris clearing mode, the control system is configured to control the EC motor to abruptly stop the cutting element after between 90 and 180 degrees of rotation.

7. The mower of claim 5, wherein, when operating the mower deck in the debris clearing mode, the control system is configured to control the EC motor to abruptly stop the cutting element after about 90 degrees of rotation.

8. The mower of claim 5, wherein, when operating the mower deck in the debris clearing mode, the control system is configured to control the EC motor to abruptly stop the cutting element after about 180 degrees of rotation.

9. The mower of claim 1, wherein, when operating the mower deck in the debris clearing mode, the control system is configured to control the EC motor to abruptly stop the cutting element after about 360 degrees of rotation.

10. The mower of claim 1, wherein, when operating the mower deck in the debris clearing mode, the control system is configured to control the EC motor to abruptly stop the cutting element intermittently over a period of time or for a number of complete rotations.

11. The mower of claim 10, wherein the control system is configured to control the EC motor to abruptly stop the cutting element after each partial rotation.

12. The mower of claim 10, wherein the control system is configured to control the EC motor to abruptly stop the cutting element after at least one full rotation each time the at least one full rotation occurs.

13. The mower of claim 1, wherein, during the debris clearing mode, the control system is configured to operate the EC motor to drive the cutting element in a reverse direction following generation of one or more shocks through the mower deck.

14. The mower of claim 1, wherein:
the cutting element is a first cutting element;
the EC motor is a first EC motor; and
the mower deck includes:
a second cutting element rotatably coupled to the housing; and
a second EC motor coupled to the housing and the second cutting element.

15. The mower of claim 14, wherein the control system is configured to:
operate the mower deck in the cutting mode where, during the cutting mode, the first EC motor and the second EC motor are controlled to drive the first cutting element and the second cutting element, respectively, for cutting grass; and
operate the mower deck in the debris clearing mode where, during the debris clearing mode, the first EC motor and the second EC motor are simultaneously controlled to drive and then abruptly stop the first cutting element and the second cutting element, respectively, to generate a combined shock through the mower deck.

16. The mower of claim 14, wherein the control system is configured to:
operate the mower deck in the cutting mode where, during the cutting mode, the first EC motor and the second EC motor are controlled to drive the first cutting element and the second cutting element for cutting grass; and
operate the mower deck in the debris clearing mode where, during the debris clearing mode, the first EC motor and the second EC motor are separately controlled to drive and then abruptly stop the first cutting element and the second cutting element, respectively, to generate separate shocks at different times through the mower deck.

17. The mower of claim 16, wherein the control system is configured to:
control the first EC motor to generate a first shock at a first point in time;
control the second EC motor to generate a second shock in a second point in time; and
repeat controlling the first EC motor and the second EC motor to re-generate the first shock and the second shock.

18. The mower of claim 1, wherein:
the mower deck is a first mower deck;
the cutting element is a first cutting element;
the EC motor is a first EC motor;
the mower includes a second mower deck coupled to the chassis, the mower deck including:
a second housing;
a second cutting element rotatably coupled to the second housing; and
a second EC motor coupled to the housing and the second cutting element;
and
the control system is configured to:
operate the first mower deck and the second mower deck in the cutting mode; and
operate the first mower deck and the second mower deck in the debris clearing mode, the first mower deck and the second mower deck being independently operable in the debris clearing mode.

19. A mower comprising:
a chassis;
a tractive element coupled to the chassis;
a mower deck coupled to the chassis, the mower deck including:
a housing;
a cutting element rotatably coupled to the housing; and
an electronic commutation (EC) motor coupled to the housing and the cutting element; and
a control system configured to:
operate the mower deck in a cutting mode where, during the cutting mode, the EC motor is controlled to drive the cutting element for cutting grass;
operate the mower deck in a debris clearing mode where, during the debris clearing mode, the EC motor is controlled to drive and then abruptly stop the cutting element after each partial rotation intermittently over a period of time or for a number of complete rotations to generate a shock through the mower deck for clearing grass accumulation between the housing and the cutting element; and
operate the EC motor to drive the cutting element in a reverse direction following generation of one or more shocks through the mower deck.

20. A mower comprising:
a chassis;
a tractive element coupled to the chassis;
a mower deck coupled to the chassis, the mower deck including:
a housing;
a first cutting element rotatably coupled to the housing;
a first electronic commutation (EC) motor coupled to the housing and the first cutting element;
a second cutting element rotatably coupled to the housing; and
a second EC motor coupled to the housing and the second cutting element; and
a control system configured to:
operate the mower deck in a cutting mode where, during the cutting mode, the first and the second EC motor are controlled to drive the first and the second cutting element for cutting grass; and
operate the mower deck in a debris clearing mode where, during the debris clearing mode, at least one of:
(a) the first EC motor and the second EC motor are simultaneously controlled to drive and then abruptly stop the first cutting element and the second cutting element, respectively, to generate a combined shock through the mower deck; or
(b) the first EC motor and the second EC motor are separately controlled to drive and then abruptly stop the first cutting element and the second cutting element, respectively, to generate separate shocks at different times through the mower deck.
